(19) United States
(12) Patent Application Publication
(10) Pub. No.: US 2025/0037021 A1
(43) Pub. Date: Jan. 30, 2025

(54) COMPUTER-READABLE RECORDING MEDIUM STORING MACHINE LEARNING PIPELINE COMPONENT DETERMINATION PROGRAM, METHOD, AND APPARATUS

(71) Applicant: Fujitsu Limited, Kawasaki-shi (JP)

(72) Inventors: Yasuhiko KONDO, Kawasaki (JP); Akira URA, Yokohama (JP); Masahiro FUKUYORI, Kawasaki (JP)

(73) Assignee: Fujitsu Limited, Kawasaki-shi (JP)

(21) Appl. No.: 18/754,391

(22) Filed: Jun. 26, 2024

(30) Foreign Application Priority Data
Jul. 26, 2023 (JP) 2023-121969

(51) Int. Cl. G06N 20/00

(52) U.S. Cl. CPC G06N 20/00

(57) ABSTRACT

A machine learning pipeline component determination program causes a computer to execute a process. The process including: obtaining a type of a first component; identifying one or more first machine learning pipelines including a component of the same type as the type of the first component among a plurality of machine learning pipelines outputted for a plurality of datasets by a program that generates machine learning pipelines including components selected from among a plurality of components depending on a task; generating one or more second machine learning pipelines in which the component of the same type is changed to the first component; and determining whether or not to add the first component to the plurality of components based on a result of comparison between a performance of each of the first machine learning pipelines and a performance of each corresponding second machine learning pipelines

### CROSS-REFERENCE TO RELATED APPLICATION

This application is based upon and claims the benefit of priority of the prior Japanese Patent Application No. 2023-121969, filed on Jul. 26, 2023, the entire contents of which are incorporated herein by reference.

### FIELD

The embodiment discussed herein is related to a computer-readable recording medium storing a machine learning pipeline component determination program, a machine learning pipeline component determination method, and a machine learning pipeline component determination apparatus.

### BACKGROUND

Automated machine learning (AutoML) searches for multiple components such as a component that executes preprocessing on data and a component (machine learning model) that executes inference, and automatically generates an optimal machine learning pipeline (hereafter also simply referred to as “pipeline”) for executing tasks.

As a technique relating to the AutoML, for example, there has been proposed a method of categorizing spend data that does not use prior in-depth knowledge of transactional data of an organization. In this method, natural language processing is applied to text data from transactional data to generate a cleaned dataset (CDS). Logs for transactions are clustered based on similarity, and form a minimum dataset (MDS). A user is requested to manually categorize the logs from each cluster of a subset, and a subset of high-value clusters is thereby selected. A model is then trained using the subset of manually-categorized clusters, and is used to predict spend categories for remaining logs with high accuracy. An AI engine automatically analyzes the prediction based on client context, and either auto-tunes the machine learning model or identifies a new subset of clusters to be manually categorized.

For example, there has been also proposed a data classification system in which efficiency of creating classifiers in an integrated classifier is improved. In this system, classification results for predetermined datasets outputted by multiple classifiers are integrated, and correspondence relationships between feature amounts of the datasets and labels being the classification results are stored as learning data. For each of unlabeled datasets in the learning data, this system calculates a simultaneous unclassified rate of the case where multiple labels are determined to be unclassified for one dataset, based on the feature amount and a classification probability outputted by the integrated classifier learning from the classification results of the respective classifiers. This system calculates a simultaneous classified probability of the case where multiple labels are classified for one dataset. This system collects a multiplication value of the simultaneous unclassified rate and the simultaneous classified probability for each label to calculate a recommendation score, determines the labels as labels for which the classifier is to be additionally created in the descending order of the recommendation score, and outputs the labels as recommendation information.

For example, there has been proposed a system for determining suitable hyperparameters for a machine learning model and a feature engineering process. In this system, a suitable machine learning model and associated hyperparameters are determined by analyzing a dataset. In this system, suitable hyperparameter values for compatible machine learning models having one or more hyperparameters in common and a compatible dataset schema are identified. Hyperparameters may be ranked according to each of their respective influences on model performance metrics, and hyperparameter values identified as having greater influence may be more aggressively searched.

For example, there is proposed a method of generating a predictive machine learning model in which selection of a prediction field is received from multiple fields in a database server, and multiple features are generated from a dataset by the database server. The multiple features are automatically generated based on at least in part on metadata associated with the dataset. In this method, the database server generates the predictive machine learning model based at least in part on the multiple features, and an indication of multiple predicted values for the prediction field is transmitted based at least in part on the predictive machine learning model.

Japanese Laid-open Patent Publication Nos. 2020-115346 and 2020-008992 and U.S. Patent Application Publication Nos. 2020/0057958 and 2019/0138946 are disclosed as related art.

### SUMMARY

According to an aspect of the embodiments, a computer-readable recording medium storing a machine learning pipeline component determination program that causes a computer to execute a process comprising: obtaining a type of a first component; identifying one or more first machine learning pipelines including a component of the same type as the type of the first component among a plurality of machine learning pipelines outputted for a plurality of datasets by a program that generates machine learning pipelines including components selected from among a plurality of components depending on a task; generating, for the respective one or more first machine learning pipelines, one or more second machine learning pipelines in which the component of the same type is changed to the first component; and determining whether or not to add the first component to the plurality of components based on a result of comparison between a performance of each of the one or more first machine learning pipelines and a performance of a corresponding one of the one or more second machine learning pipelines

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a reference method;

FIG. 2 is a functional block diagram of a machine learning pipeline component determination apparatus;

FIG. 3 is a diagram illustrating an example of a subset DB;

FIG. 4 is a diagram illustrating an example of classification of components into subsets;

FIG. 5 is a diagram illustrating an example of a performance DB;

FIG. 6 is a diagram for explaining an example of calculation of metadata;

FIG. 7 is a diagram illustrating an example of metadata for each component for each dataset;

FIG. 8 is a diagram illustrating an example of aggregated metadata;

FIG. 9 is a diagram for explaining obtaining of a subset for a target component;

FIG. 10 is a diagram illustrating an outline of the present embodiment;

FIG. 11 is a block diagram illustrating a schematic configuration of a computer that functions as a machine learning pipeline component determination apparatus;

FIG. 12 is a flowchart illustrating an example of preparation processing; and

FIG. 13 is a flowchart illustrating an example of determination processing;

### DESCRIPTION OF EMBODIMENTS

In AutoML, what kinds of components are included in a search range being a set of components are important. When a new component not included in an existing search range is generated, whether the new component is to be added to the search range or not has to be determined. For example, when the new component is a component that is capable of performing only processing executable by the components included in the existing search range, the new component does not have to be added to the search range. It is desirable that the above-mentioned determination of whether or not to add the new component to the search range is automatically performed.

Accordingly, the following is conceivable. The AutoML is executed on the search range before addition of a target component and the search range after the addition for many datasets, and whether or not to add the target component is determined based on whether a performance of a pipeline generated after the addition of the target component is improved from that before the addition or not.

However, evaluating the performances of the pipelines generated by executing the AutoML on all combinations of multiple components included in the search ranges before and after the addition of the target component leads to very high calculation cost.

As one aspect, an object of the disclosed technique is to reduce a calculation cost of determining whether or not to add a new component to a search range of automatic machine learning.

Hereinafter, an example of an embodiment according to the disclosed technique is explained with reference to the drawings.

Before explaining details of the embodiment, explanation is given of a reference method assumable for determination of whether or not to add a new component to a search range of AutoML.

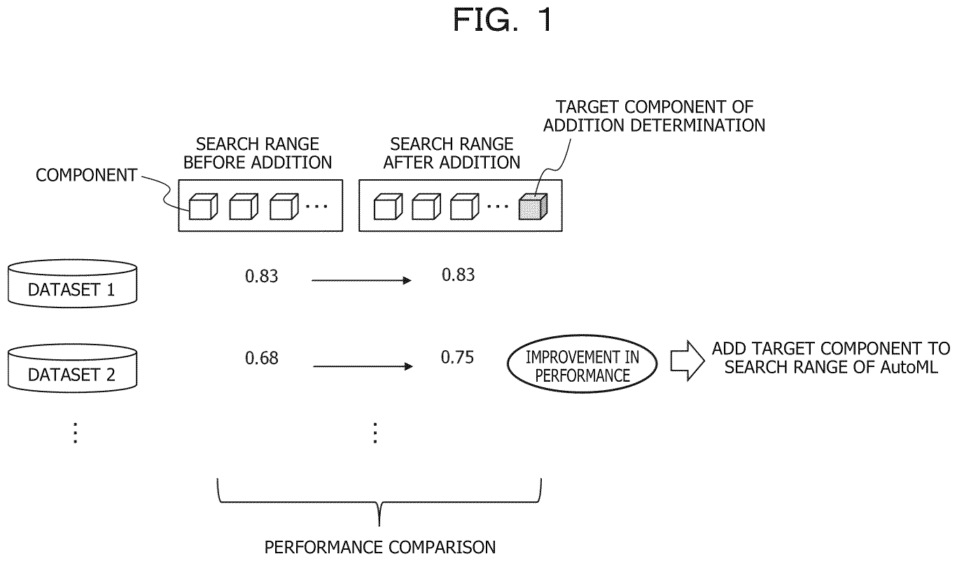

As illustrated in FIG. 1, an information processing apparatus that executes the reference method executes the AutoML on many datasets by using each of search ranges before and after addition of a target component. The search ranges are each a set of multiple components such as components that execute preprocessing on data and components (machine learning model) that execute inference. The AutoML is executed to generate pipelines for all combinations of components included in the search range. The pipelines are each a set in which an entire system that executes tasks is built with the components that execute the preprocessing and the components that execute inference, and each express the order of usage of the components. In the following explanation, the target component is assumed to be the component that executes the preprocessing, and the component that executes the preprocessing is simply referred to as “component” in some cases.

The information processing apparatus executes the AutoML to identify the highest performance among performances of the respective multiple pipelines generated from the search range before the addition of the target component, for each dataset. Similarly, the information processing apparatus identifies the highest performance among performances of the respective multiple pipelines generated from the search range after the addition of the target component, for each dataset. The performance is, for example, accuracy of a prediction result outputted from the pipeline or the like. The information processing apparatus evaluates whether or not the performance after the addition of the target component has improved from that before the addition, for each of the multiple datasets. If the performance has improved in any of the datasets, the information processing apparatus determines to add the target component to the search range.

Evaluating the performances of all pipelines formed of all combinations of the components included in the search ranges before and after the addition of the target component for all datasets as described above leads to an enormous calculation cost.

Accordingly, in the present embodiment, the calculation cost is reduced by performing the evaluation while narrowing down the pipelines to be evaluated among the pipelines formed of the combinations of the components included in the search ranges. Hereinafter, a machine learning pipeline component determination apparatus according to the present embodiment will be described in detail.

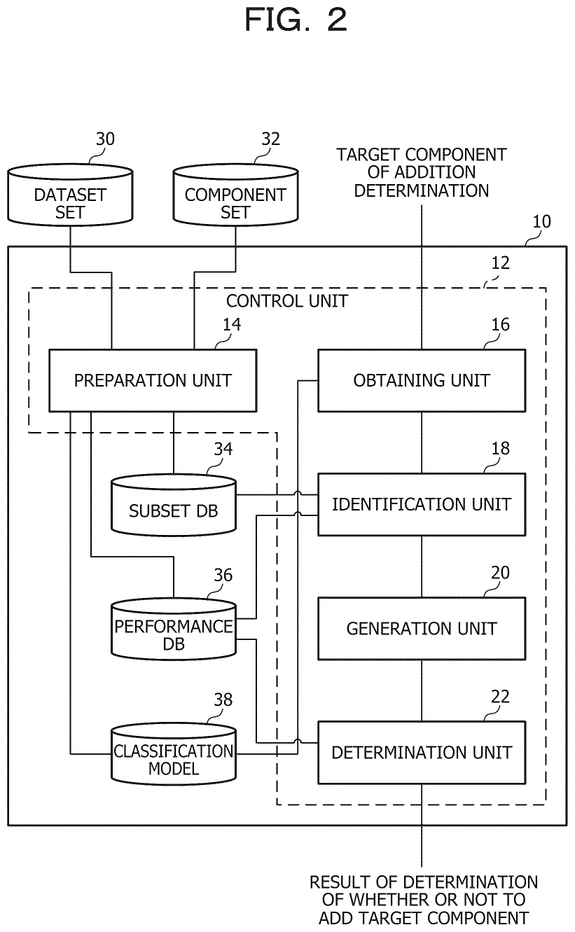

As illustrated in FIG. 2, the machine learning pipeline component determination apparatus 10 functionally includes a control unit 12. The control unit 12 includes a preparation unit 14, an obtaining unit 16, an identification unit 18, a generation unit 20, and a determination unit 22. A subset database (DB) 34, a performance DB 36, and a classification model 38 are stored in a predetermined storage area of the machine learning pipeline component determination apparatus 10.

The preparation unit 14 obtains a dataset set 30 and a component set 32. Multiple datasets are included in the dataset set 30. Each dataset includes multiple pieces of data formed of one or more feature amounts about the respective columns. The component set 32 is a set of components to be the search range of the AutoML. As described above, in the present embodiment, the target component of the addition determination is assumed to be the component that executes preprocessing on data, and the components included in the component set 32 are also assumed to be the components that execute preprocessing. Although the component (machine learning model) that executes inference is also used for generation of the pipeline to be described later, description of the component that executes inference in the component set 32 is omitted in the present embodiment.

The preparation unit 14 classifies each of the components included in the component set 32 into one of multiple subsets. The subsets are examples of “types” in the disclosed technique. For example, the preparation unit 14 may randomly classify the components into each subset such that the components are evenly classified into each subset. For example, in the case where each component is a component provided in a library of Python or the like, the preparation unit 14 may classify the components into each subset based on packages to which the components belong in the library.

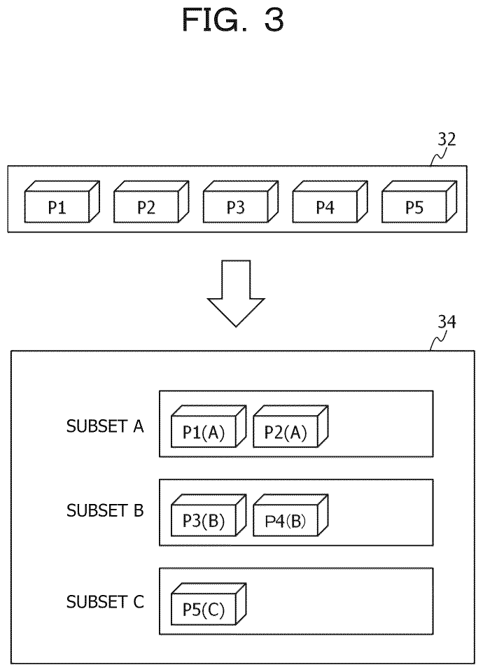

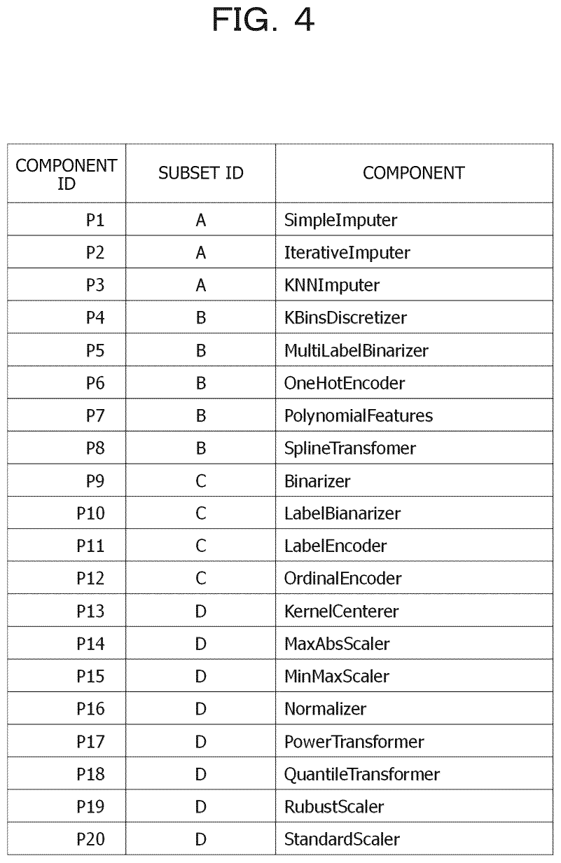

As illustrated in FIG. 3, the preparation unit 14 stores component IDs that are identification information of the components and subset IDs that are identification information of the subsets in the subset DB 34 in association with one another. In the example illustrated in FIG. 3, each box represents one component, and “Pi” in the box is the component ID. In the example illustrated in FIGS. 3, i=1, 2, 3, 4, and 5. FIG. 3 illustrates an example in which each component is classified into one of three subsets. The subset IDs (A, B, and C in the example of FIG. 3) in parentheses are added after the component IDs, to the classified components. FIG. 4 illustrates an example in which components of preprocessing in scikit-learn, which is an open-source machine learning library implemented in Python, are used as an example, and each component is classified into one of multiple subsets (A, B, C, and D in the example of FIG. 4).

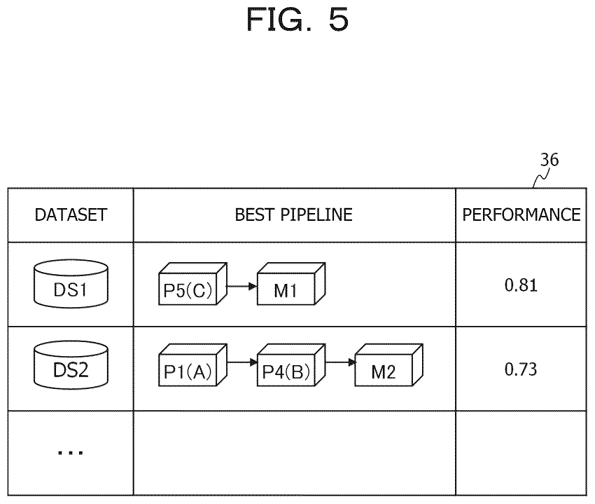

The preparation unit 14 executes the AutoML for each of the multiple datasets included in the dataset set 30, and identifies a pipeline having the highest performance (hereafter referred to as “best pipeline”) and the performance of the best pipeline. For example, as illustrated in FIG. 5, the preparation unit 14 stores the identified best pipeline and the performance in association with each other in the performance DB 36 for each dataset. The components denoted by M1 and M2 in FIG. 5 are components (machine learning models) that execute inference.

The preparation unit 14 trains the classification model 38, which is a machine learning model for subset classification of components, by using training data in which features of the respective multiple components included in the component set 32 are associated with the subsets into which the components are classified. When a feature of a component is inputted into the classification model 38, the classification model 38 outputs a subset into which the component is to be classified.

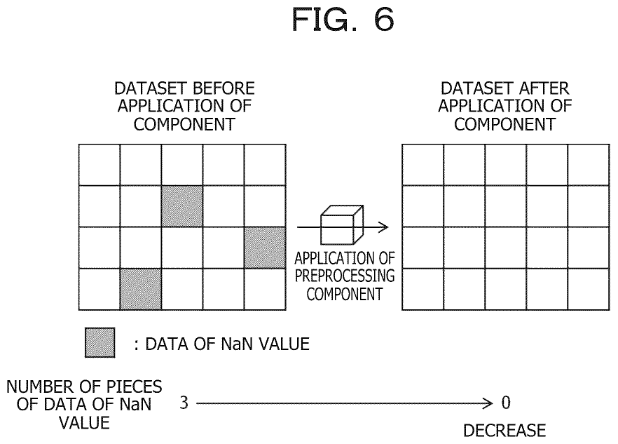

For example, the preparation unit 14 calculates metadata indicating a change in each dataset in the case where each component is applied to the each dataset, as the feature. For example, as illustrated in FIG. 6, the preparation unit 14 calculates a change, for example, an increase, no change, or decrease in the number of pieces of NaN value data included in the dataset after the application of the component of preprocessing, with respect to the number of pieces of NaN value data included in the dataset before the application of the component of preprocessing, as the metadata.

The preparation unit 14 may calculate, for example, a change in the total number of columns before and after the application of the preprocessing of the component to the dataset, a type of a changed column, and the like as other pieces of metadata. The preparation unit 14 may also calculate a change in the total number of instances, a frequency of a value of a column, a maximum value of the changed column, a minimum value of the changed column, a standard deviation of the changed column, a ratio between a median value and the maximum value, a ratio between the median value and the minimum value, a frequency of 0 of the changed column, and the like.

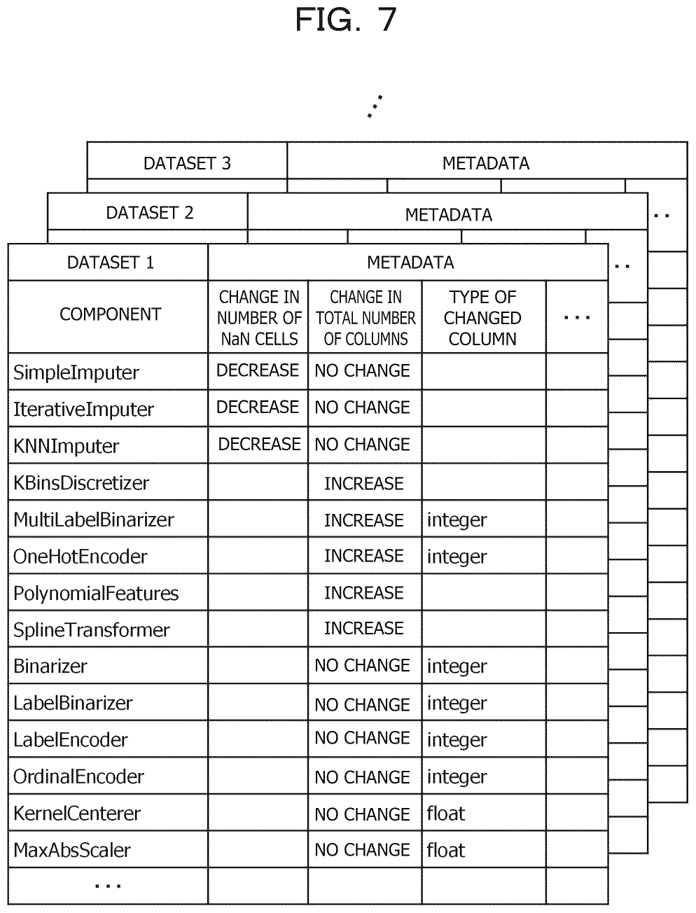

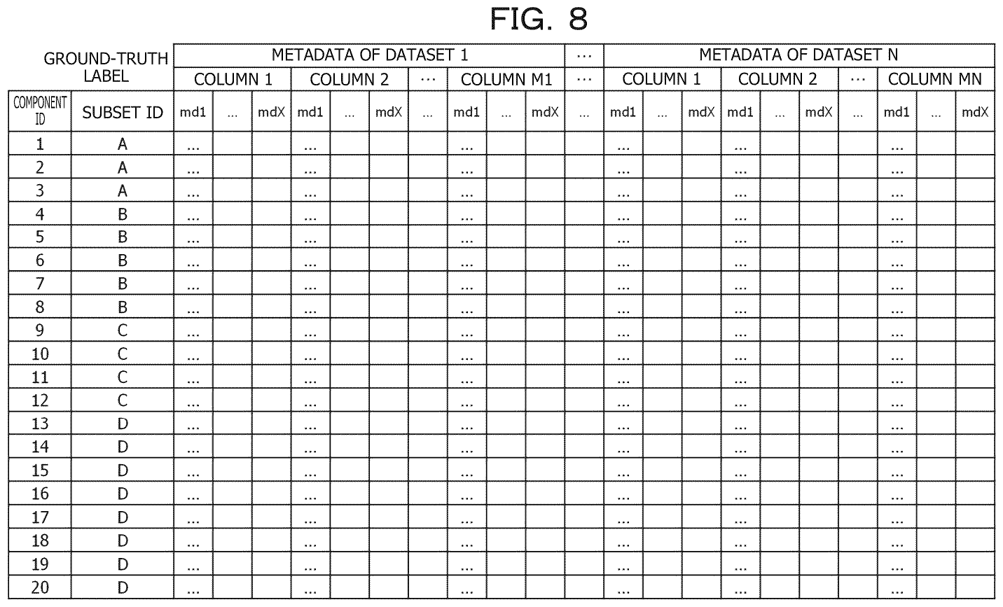

As illustrated in FIG. 7, the preparation unit 14 calculates pieces of metadata of the respective datasets, for each component. As illustrated in FIG. 8, the preparation unit 14 aggregates the pieces of metadata of the respective datasets for each component, and generates aggregated metadata. For example, the preparation unit 14 generates the aggregated metadata by horizontally coupling the pieces of metadata of the respective datasets, for each component. In the example of FIG. 8, there are N datasets. The number of columns in the dataset 1 is M1, the number of columns in the dataset 2 is M2, . . . , and the number of columns in the dataset N is MN. When X types of metadata are calculated, the metadata in each column is metadata md1, metadata md2, . . . , and metadata mdX.

The preparation unit 14 gives the aggregated metadata of each component the subset ID of the subset into which the each component is classified as a ground-truth label, and generates the resultant data as training data. The preparation unit 14 then trains the classification model 38 such that a subset classification result outputted when the aggregated metadata is inputted into the classification model 38 matches the ground-truth label.

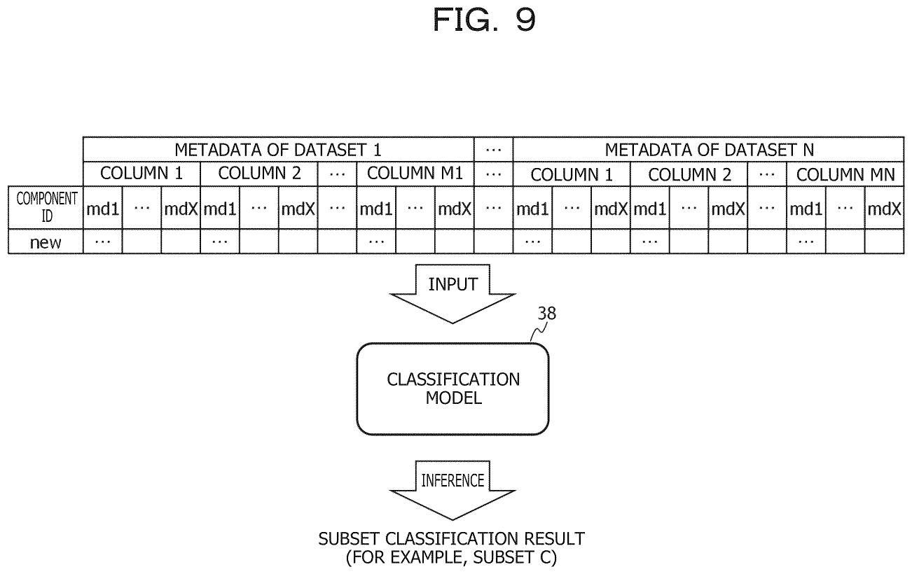

The obtaining unit 16 obtains the target component of the addition determination, and obtains the subset of the target component. The target component is an example of “first component” in the disclosed technique. For example, as illustrated in FIG. 9, the obtaining unit 16 calculates metadata for the target component as in the above-mentioned processing of the preparation unit 14, and generates the aggregated metadata. In FIG. 9, the component ID of the target component is “new”. The obtaining unit 16 inputs the generated aggregated metadata into the classification model 38 trained by the preparation unit 14, and obtains the subset classification result of the target component.

The identification unit 18 identifies one or more pipelines including a component of the same subset as the subset of the target component among the best pipelines stored in the performance DB 36, as evaluation target pipelines. The evaluation target pipelines are an example of “one or more first machine learning pipelines” in the disclosed technique. For example, the identification unit 18 refers to the subset DB 34 to identify the components included in the same subset as the subset of the target component obtained by the obtaining unit 16. The identification unit 18 then performs searching with the best pipelines stored in the performance DB 36 being evaluation target candidates, and identifies the evaluation target candidate best pipelines including the identified components as the evaluation target best pipelines.

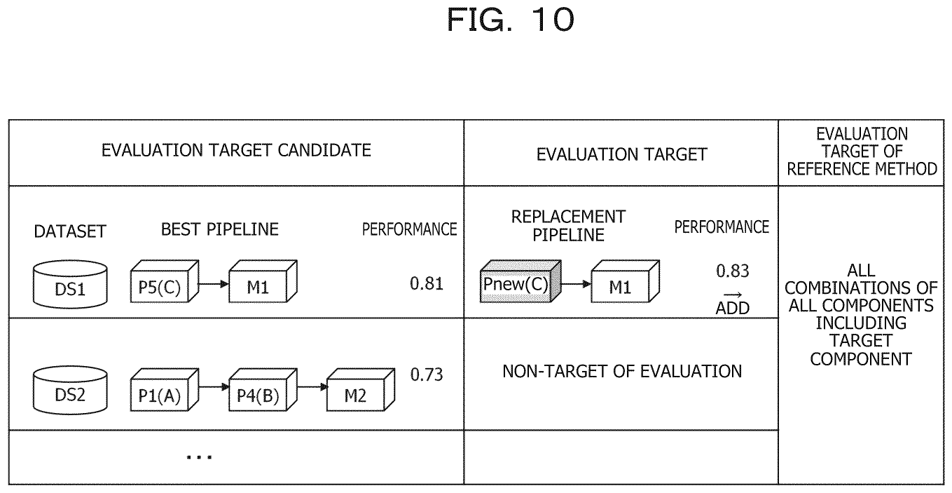

For example, assume that the subset C is obtained as the subset of the target component. In this case, as illustrated in FIG. 10, the identification unit 18 identifies the best pipeline for the dataset 1, which includes the component of the subset C, among the evaluation target candidate best pipelines as the evaluation target. The identification unit 18 does not identify the best pipeline for the dataset 2 including no component of the subset C, as the evaluation target, for example, sets the best pipeline for the dataset 2 as a non-target of evaluation.

For each of the evaluation target pipelines, the generation unit 20 generates a replacement pipeline in which the component of the same subset as the target component is changed to the target component. The replacement pipeline is an example of “one or more second machine learning pipelines” in the disclosed technique. In the example illustrated in FIG. 10, the generation unit 20 generates the replacement pipeline by changing the component “P5 (C)” included in the best pipeline for the dataset 1 to the target component “Pnew (C)”.

The determination unit 22 determines whether or not to add the target component to the search range of the AutoML based on a result of comparison between the performance of each evaluation target pipeline and the performance of the corresponding replacement pipeline. For example, the determination unit 22 evaluates the performance of the replacement pipeline, compares the evaluated performance with the performance of the evaluation target pipeline, for example, the pipeline before the replacement, and determines to add the target component to the search range of the AutoML when the performance is improved. When the performance is not improved, the determination unit 22 determines not to add the target component to the search range of the AutoML. In the case where multiple evaluation target best pipelines are identified, for example, the determination unit 22 may determine to add the target component to the search range of the AutoML when the performance is improved for any one of the evaluation target best pipelines. The determination unit 22 outputs the determination result on whether or not to add the target component to the search range of the AutoML.

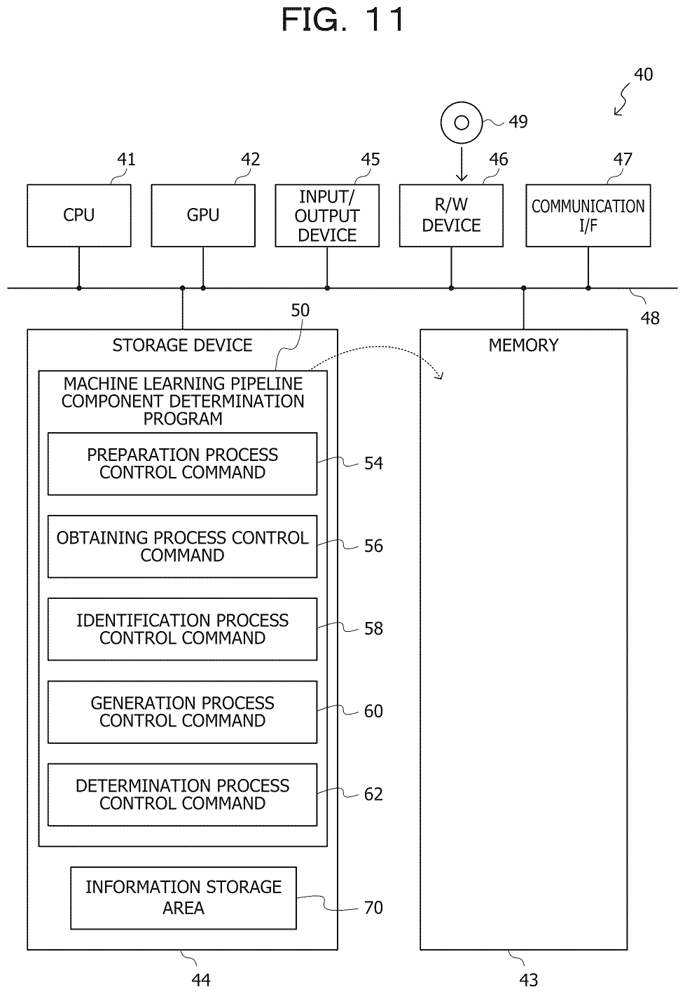

For example, the machine learning pipeline component determination apparatus 10 may be implemented by a computer 40 illustrated in FIG. 11. The computer 40 includes a central processing unit (CPU) 41, a graphics processing unit (GPU) 42, a memory 43 serving as a temporary storage area, and a non-volatile storage device 44. The computer 40 also includes an input/output device 45 such as an input device and a display device, and a read/write (R/W) device 46 that controls reading and writing of data from and to a storage medium 49. The computer 40 includes a communication interface (I/F) 47 that is coupled to a network such as the Internet. The CPU 41, the GPU 42, the memory 43, the storage device 44, the input/output device 45, the R/W device 46, and the communication I/F 47 are coupled to one another via a bus 48.

For example, the storage device 44 is a hard disk drive (HDD), a solid-state drive (SSD), a flash memory, or the like. A machine learning pipeline component determination program 50 for causing the computer 40 to function as the machine learning pipeline component determination apparatus 10 is stored in the storage device 44 serving as a storage medium. The machine learning pipeline component determination program 50 includes a preparation process control command 54, an obtaining process control command 56, an identification process control command 58, a generation process control command 60, and a determination process control command 62. The storage device 44 also includes an information storage area 70 in which information forming each of the subset DB 34, the performance DB 36, and the classification model 38 is stored.

The CPU 41 reads the machine learning pipeline component determination program 50 from the storage device 44, loads the machine learning pipeline component determination program 50 onto the memory 43, and sequentially executes the control commands included in the machine learning pipeline component determination program 50. The CPU 41 operates as the preparation unit 14 illustrated in FIG. 2 by executing the preparation process control command 54. The CPU 41 operates as the obtaining unit 16 illustrated in FIG. 2 by executing the obtaining process control command 56. The CPU 41 operates as the identification unit 18 illustrated in FIG. 2 by executing the identification process control command 58. The CPU 41 operates as the generation unit 20 illustrated in FIG. 2 by executing the generation process control command 60. The CPU 41 operates as the determination unit 22 illustrated in FIG. 2 by executing the determination process control command 62. The CPU 41 reads the information from the information storage area 70, and loads each of the subset DB 34, the performance DB 36, and the classification model 38 onto the memory 43. The computer 40 that executes the machine learning pipeline component determination program 50 thereby functions as the machine learning pipeline component determination apparatus 10. The CPU 41 that executes the program is hardware. Part of the program may be executed by the GPU 42.

The functions implemented by the machine learning pipeline component determination program 50 may be implemented by, for example, a semiconductor integrated circuit, more specifically, an application-specific integrated circuit (ASIC), a field-programmable gate array (FPGA), or the like.

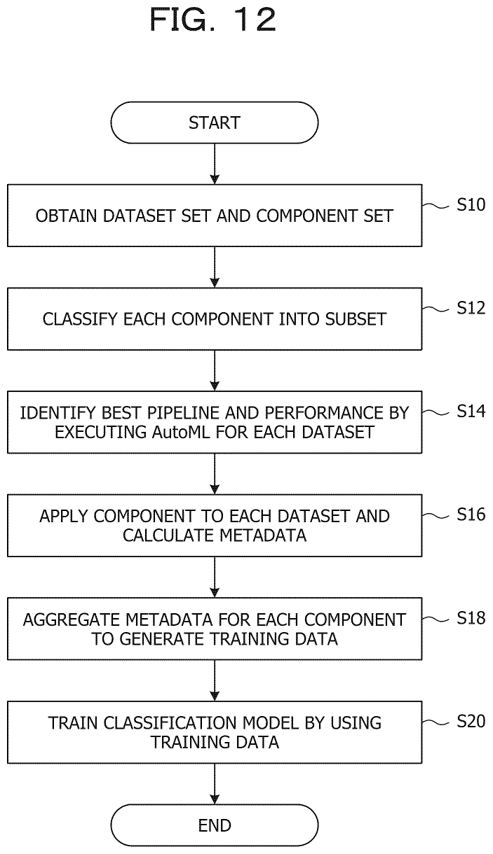

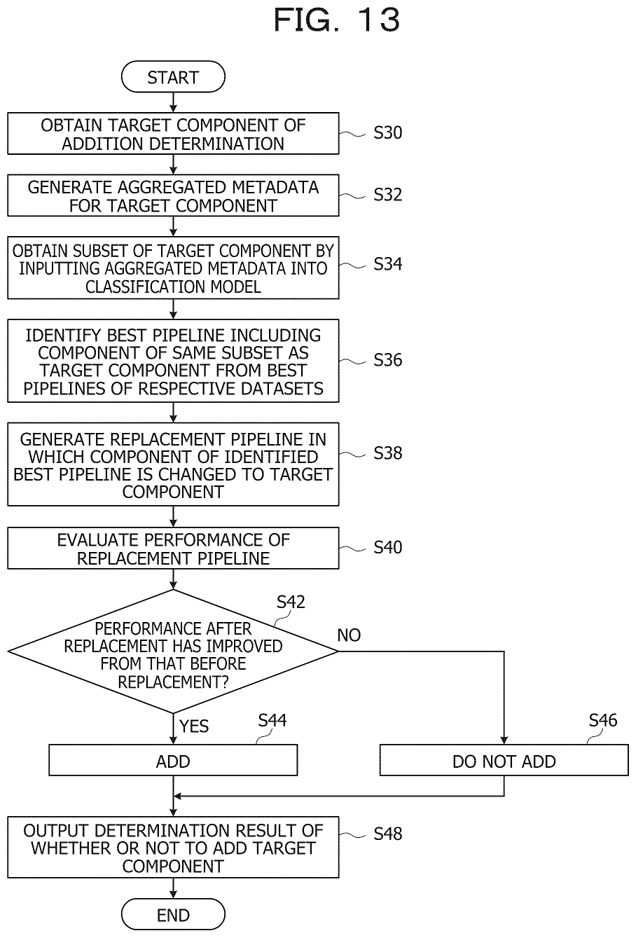

Operations performed by the machine learning pipeline component determination apparatus 10 according to the present embodiment will be explained next. First, the machine learning pipeline component determination apparatus 10 executes preparation processing illustrated in FIG. 12. The machine learning pipeline component determination apparatus 10 then executes determination processing illustrated in FIG. 13. The preparation processing and the determination processing are an example of the machine learning pipeline component determination method of the disclosed technique.

The preparation processing will be explained with reference to FIG. 12.

In step S10, the preparation unit 14 obtains the dataset set 30 and the component set 32. Next, in step S12, the preparation unit 14 classifies each of the components included in the component set 32 into one of the multiple subsets, and stores the component IDs and the subset IDs in the subset DB 34 in association with one another.

Next, in step S14, the preparation unit 14 executes the AutoML on each of the multiple datasets included in the dataset set 30 to identify the best pipeline and the performance thereof. The preparation unit 14 then stores the identified best pipeline and the performance in the performance DB 36 in association with each other, for each dataset.

Next, in step S16, the preparation unit 14 calculates the change in each dataset in the case where each component is applied to the each dataset, as the metadata. Next, in step S18, the preparation unit 14 aggregates the pieces of metadata of the respective datasets for each component to generate the aggregated metadata, gives the aggregated metadata of the each component the subset ID of the subset into which the each component is classified as the ground-truth label, and generates the resultant data as the training data. Next, in step S20, the preparation unit 14 trains the classification model 38 by using the training data, and the preparation processing ends.

Next, the determination processing will be explained with reference to FIG. 13.

In step S30, the obtaining unit 16 obtains the target component of the addition determination. Next, in step S32, the obtaining unit 16 calculates the metadata for the target component, and generates the aggregated metadata. Next, in step S34, the obtaining unit 16 inputs the generated aggregated metadata into the trained classification model 38, and obtains the subset classification result of the target component.

Next, in step S36, the identification unit 18 identifies one or multiple pipelines including a component of the same subset as the subset of the target component among the best pipelines stored in the performance DB 36, as the evaluation target pipelines. Next, in step S38, the generation unit 20 generates, for each of the evaluation target pipelines, the replacement pipeline in which the component of the same subset as the target component is changed to the target component.

Next, in step S40, the determination unit 22 evaluates the performance of the replacement pipeline. Next, in step S42, the determination unit 22 compares the performance of the pipeline before the replacement and that after the replacement, and determines whether the performance is improved or not. The processing proceeds to step S44 when the performance is improved, and proceeds to step S46 when the performance is not improved.

In step S44, the determination unit 22 determines to add the target component to the search range of the AutoML. Meanwhile, in step S46, the determination unit 22 determines not to add the target component to the search range of the AutoML. Next, in step S48, the determination unit 22 outputs the determination result of whether or not to add the target component to the search range of the AutoML, and the determination processing ends.

As described above, the machine learning pipeline component determination apparatus according to the present embodiment obtains the subset into which the target component of the addition determination is classified. The machine learning pipeline component determination apparatus identifies the evaluation target pipeline including the component of the same subset as the target component, among the multiple pipelines outputted for the multiple datasets by the AutoML. The machine learning pipeline component determination apparatus generates the replacement pipeline in which the component of the same subset is changed to the target component, for each evaluation target pipeline. The machine learning pipeline component determination apparatus determines whether or not to add the target component to the search range of the AutoML, based on the result of comparison between the performance of each evaluation target pipeline and the performance of the corresponding replacement pipeline. This may reduce the calculation cost for determining whether or not to add a new component to the search range of the automatic machine learning.

For example, as illustrated in FIG. 10, in the reference method described above, the pipelines of all combinations of components included in each of the search ranges before and after the addition of the target component are the evaluation targets. Meanwhile, in the present embodiment, the pipeline including the component of the same subset as the target component among the best pipelines of the respective datasets and the replacement pipeline in which the component in the pipeline is changed to the target component are the evaluation targets. In the present embodiment, since the evaluation targets for the determination of whether or not to add the target component are narrowed down as described above, the calculation cost may be reduced.

Although the case where the subset into which the target component is classified is obtained by using the classification model trained in advance is explained in the above-mentioned embodiment, the embodiment is not limited to this. For example, each component is vectorized by using the aggregated metadata as described above, and is clustered in a vector space for each subset. A subset corresponding to a cluster whose distance between the center of each cluster and the vector indicated by the aggregated metadata of the target component is smallest may be obtained as the subset into which the target component is classified.

Although the machine learning pipeline component determination program is stored (installed) in advance in the storage device in the above-mentioned embodiment, the embodiment is not limited to this. The program according to the disclosed technique may be provided in a form in which the program is stored in a storage medium such as a compact disc read-only memory (CD-ROM), a Digital Versatile Disc ROM (DVD-ROM), or a Universal Serial Bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a machine learning pipeline component determination program that causes a computer to execute a process comprising:
obtaining a type of a first component;
identifying one or more first machine learning pipelines including a component of the same type as the type of the first component among a plurality of machine learning pipelines outputted for a plurality of datasets by a program that generates machine learning pipelines including components selected from among a plurality of components depending on a task;
generating, for the respective one or more first machine learning pipelines, one or more second machine learning pipelines in which the component of the same type is changed to the first component; and
determining whether or not to add the first component to the plurality of components based on a result of comparison between a performance of each of the one or more first machine learning pipelines and a performance of a corresponding one of the one or more second machine learning pipelines.

2. The non-transitory computer-readable recording medium according to claim 1, wherein
the obtaining the type of the first component includes classifying the plurality of components into a plurality of types and classifying the first component into one of the plurality of types to obtain the type of the first component.

3. The non-transitory computer-readable recording medium according to claim 2, wherein
the type of the first component is obtained by inputting a feature of the first component into a machine learning model trained to output the type of the component when a feature of the component is inputted, by using training data in which the feature of each of the plurality of components and the type into which each of the components is classified are associated with each other.

4. The non-transitory computer-readable recording medium according to claim 3, wherein
each of the components is a component that executes preprocessing on a dataset, and
a change in the dataset in a case where the component is applied to the dataset is used as the feature.

5. The non-transitory computer-readable recording medium according to claim 1, wherein
the plurality of machine learning pipelines are machine learning pipelines with highest performances for the plurality of datasets, respectively.

6. A machine learning pipeline component determination method to be performed by a computer, the method comprising:
obtaining a type of a first component;
identifying one or more first machine learning pipelines including a component of the same type as the type of the first component among a plurality of machine learning pipelines outputted for a plurality of datasets by a program that generates machine learning pipelines including components selected from among a plurality of components depending on a task;
generating, for the respective one or more first machine learning pipelines, one or more second machine learning pipelines in which the component of the same type is changed to the first component; and
determining whether or not to add the first component to the plurality of components based on a result of comparison between a performance of each of the one or more first machine learning pipelines and a performance of a corresponding one of the one or more second machine learning pipelines.

7. The machine learning pipeline component determination method according to claim 6, wherein
the obtaining the type of the first component includes classifying the plurality of components into a plurality of types and classifying the first component into one of the plurality of types to obtain the type of the first component.

8. The machine learning pipeline component determination method according to claim 7, wherein
the type of the first component is obtained by inputting a feature of the first component into a machine learning model trained to output the type of the component when a feature of the component is inputted, by using training data in which the feature of each of the plurality of components and the type into which each of the components is classified are associated with each other.

9. The machine learning pipeline component determination method according to claim 8, wherein
each of the components is a component that executes preprocessing on a dataset, and
a change in the dataset in a case where the component is applied to the dataset is used as the feature.

10. The machine learning pipeline component determination method according to claim 6, wherein
the plurality of machine learning pipelines are machine learning pipelines with highest performances for the plurality of datasets, respectively.

11. A machine learning pipeline component determination apparatus comprising:
a memory, and
a processor coupled to the memory and configure to:
obtain a type of a first component;
identify one or more first machine learning pipelines including a component of the same type as the type of the first component among a plurality of machine learning pipelines outputted for a plurality of datasets by a program that generates machine learning pipelines including components selected from among a plurality of components depending on a task;
generate, for the respective one or more first machine learning pipelines, one or more second machine learning pipelines in which the component of the same type is changed to the first component; and
determine whether or not to add the first component to the plurality of components based on a result of comparison between a performance of each of the one or more first machine learning pipelines and a performance of a corresponding one of the one or more second machine learning pipelines.

12. The machine learning pipeline component determination apparatus according to claim 11, wherein
the obtain the type of the first component includes classifying the plurality of components into a plurality of types and classifying the first component into one of the plurality of types to obtain the type of the first component.

13. The machine learning pipeline component determination apparatus according to claim 12, wherein
the type of the first component is obtained by inputting a feature of the first component into a machine learning model trained to output the type of the component when a feature of the component is inputted, by using training data in which the feature of each of the plurality of components and the type into which each of the components is classified are associated with each other.

14. The machine learning pipeline component determination apparatus according to claim 13, wherein
each of the components is a component that executes preprocessing on a dataset, and
a change in the dataset in a case where the component is applied to the dataset is used as the feature.

15. The machine learning pipeline component determination apparatus according to claim 11, wherein
the plurality of machine learning pipelines are machine learning pipelines with highest performances for the plurality of datasets, respectively.
